(19) United States
(12) Patent Application Publication
(10) Pub. No.: US 2008/0303240 A1
(43) Pub. Date: Dec. 11, 2008

(54) BICYCLE FORK ASSEMBLY WITH INTEGRAL CROWN AND STEER TUBE

(76) Inventors: Barry Lewis, Waterloo, WI (US); Tyler Jay Pilger, Sun Prairie, WI (US)

Correspondence Address: BOYLE FREDRICKSON S.C., 840 North Plankinton Avenue, MILWAUKEE, WI, 53203, US

(21) Appl. No.: 11/760,400

(22) Filed: Jun. 8, 2007

(51) Int. Cl. B62K 21/04; H05B 1/00

(52) U.S. Cl. 280/276; 219/150 R

(57) ABSTRACT

A fork assembly for a bicycle that includes a fork crown with an integrally formed steer tube and a pair of fork receiving pockets. The crown and the steer tube are preferably forged of an aluminum material. Each of a pair of fork blades includes a crown end that has a contour that substantially matches a contour of a respective receiving pocket such that each of the pair of fork blades can be bonded to the crown thereby providing a lightweight and robust fork, fork crown, and steer tube assembly.

### BACKGROUND OF THE INVENTION

The present invention relates generally to bicycles and, more particularly, to a light weight multi-material fork assembly.

A typical fork assembly generally includes a fork crown constructed to engage a pair of downward extending forks. A steer tube is constructed to engage mating structure and be secured to the fork crown. Typically, the steer tube and fork crown are constructed of aluminum-type material whereas the forks, or at least a portion thereof, may be constructed of the composite or carbon and/or glass fiber material. The fork crown is often two dimensionally forged and then machined to a proximate finish or net shape.

The fork crown is frequently formed with a pair of protrusions positioned on generally opposite sides of the fork crown. The protrusions are constructed to engage the inside of the composite fork legs. The faces of the protrusions increase the surface area of the interface between the aluminum fork crown and the composite forks. Such a construction provides a greater bonding area between the two components.

Once fully assembled and bonded, the assembly is again machine to ensure a generally planar transition between the fork crown and the fork legs thereby providing an aesthetic and aerodynamic finish. In addition to the exterior surface machining, a surface of a cavity of each fork leg is also commonly machined to ensure a relatively consistent bond-gap between a respective fork leg and the respective protruding portion of the fork crown.

Each fork blade or leg is typically made from a carbon fiber and/or glass fiber material that is held together with an epoxy resin matrix. Such fork blades are typically molded using matched female tooling and a pressure-generating material or pressurized bladder configured to form the general shape of the cavity of each fork leg configured to engage the corresponding protrusion of the fork crown. Construction and preparation of the respective fork assembly components is time consuming and labor intensive.

Construction of the steer tube also commonly requires extensive manufacturing processes to ensure a secure engagement between the steer tube and the fork crown. An inner diameter of the steer tube is commonly stepped or tapered and is formed using a butting process well-known to steer tube manufacture. The steer tube also includes a plug end constructed for bonding the steer tube to the fork crown. The plug end is generally formed after the butting process and is typically done by swaging the end of the steer tube that engages the fork crown.

Although such a known manufacturing and assembly process generates a fork assembly that is aesthetically pleasing and fairly robust, such fork assemblies are not without their drawbacks. The assembly provides a relatively heavy fork assembly having a fork crown and steer tube constructed of a relatively solid aluminum material. The fork crown and steer tube are commonly constructed of the aluminum based material and sized to withstand the stresses and strains associated with bicycle operation. The size and material of the steer tube assembly contributes to the overall weight of the bicycle. Furthermore, due to the stress concentrations associated with the interface of the steer tube and the fork crown, additional material is commonly associated with this interface area thereby further increasing the mass of the fork assembly. Understandably, subassembly weight is an important consideration of bicycle design. Riders commonly prefer a bicycle that is lightweight and can provide the performance to which they are accustomed.

The fairly complex manufacture of such fork assemblies also presents several undesirable manufacturing attributes. The multiple machining and complex forging, molding, or casting requirements of such assemblies increase the cost and skilled personnel expense associated with the generation of each unit. Whereas the pre and post bond machining of the fork assembly components ensures a generally uniform and repeatable assembly, such manufacturing processes have a greater than ideal per unit cycle time. Although the post bond machining of the crown race ensures that the fork crown is constructed to be concentrically supported by a bicycle frame relative to the steer tube, these extensive production procedures increase the per unit assembly time as well as the requisite skill level of assembly and manufacturing personnel.

Accordingly, it would be desirable to have a fork assembly that is both robust and lightweight. It is further desired to provide a method of forming a fork assembly whose components can be efficiently and repeatably produced and assembled.

### BRIEF DESCRIPTION OF THE INVENTION

The present invention provides a system and method of forming a bicycle fork assembly that overcomes the aforementioned drawbacks. A fork assembly for a bicycle according to one aspect of the invention includes a fork crown with an integrally formed steer tube and a pair of fork receiving pockets. The crown and the steer tube are preferably formed of an aluminum material. Each of a pair of fork blades includes a crown end that has a contour that substantially matches a contour of a respective receiving pocket such that each of the pair of fork blades can be bonded to the crown thereby providing a lightweight and robust fork, fork crown, and steer tube assembly.

Another aspect of the invention discloses a bicycle fork assembly that has a fork crown and a steer tube that is formed integrally with the fork crown. The steer tube extends from the fork crown in a first direction. A pair of cavities is formed in the fork crown. Each cavity has an opening that faces a direction generally opposite the first direction. The fork assembly includes a pair of fork legs. Each fork leg is formed of a non-metal material and has a first end that is contoured to substantially match a contour of one of the cavities such that the pair of fork legs can be bonded into the cavities.

A further aspect of the invention is discloses as a bicycle assembly that has a frame assembly constructed to support a rear wheel and a seat. The bicycle assembly includes a front wheel support assembly that has a steer tube constructed to be rotationally connected to the frame assembly. A fork crown is integrally formed with the steer tube and is constructed to extend below a forward portion of the frame assembly. A pair of recesses is formed into generally opposite ends of the fork crown such that each recess has a single opening orientated such that the openings face in a common direction. A pair of composite fork legs is bonded to the fork crown. Each fork leg has a projection that is constructed to cooperate with one of the recesses such that the projection is entirely enclosed by the fork crown when the fork leg is bonded to the fork crown. Such a construction provides a bicycle that has an aerodynamic and robust fork assembly.

A method of forming a fork assembly is disclosed as another aspect of the invention. The method includes forming a fork crown and a steer tube as a one-piece part. A cavity is formed through the steer tube and a pair of pockets is formed in the fork crown. A fork leg is formed of a composite material that is different than a material of the one-piece part. An upper portion of the fork leg is contoured during formation to correspond to a contour of one of the pockets. The upper portion of the fork leg is bonded into one of the pockets of the fork crown such that an outer surface of the fork leg is generally aligned with an outer surface of the fork crown. Such a construction provides a fork crown and steer tube assembly that is efficient to produce and requires a reduced amount of post cast machining.

Another aspect of the invention discloses a method of forming a fork assembly that includes concurrently forming a steer tube for engaging a head tube and a fork crown and integrally forming a bearing race on one of the steer tube and the fork crown. Such a construction simplifies the assembly of a bicycle and provides a robust interface between the fork assembly and the frame of the bicycle.

These and various other features and advantages of the present invention will be made apparent from the following detailed description and the drawings.

### BRIEF DESCRIPTION OF THE DRAWINGS

The drawings illustrate one preferred embodiment presently contemplated for carrying out the invention.

In the drawings:

FIG. 1 is an elevational view of the bicycle equipped with a fork assembly according to the present invention;

FIG. 2 is a perspective view of the fork assembly shown in FIG. 1 removed from the bicycle;

FIG. 3 is a perspective view of a portion of the fork assembly shown in FIG. 2 with a pair of fork legs exploded from a fork crown; and

FIG. 4 is a cross-sectional view of a portion of the fork assembly shown in FIG. 2.

### DETAILED DESCRIPTION OF THE PREFERRED EMBODIMENT

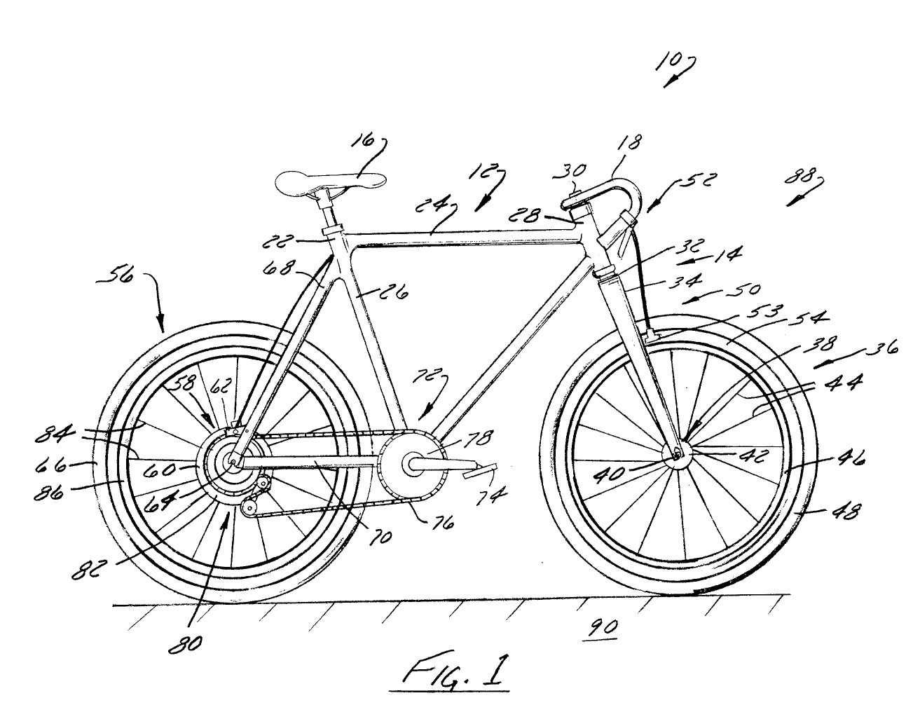

FIG. 1 shows a bicycle 10 having a frame 12 constructed to accommodate a fork assembly 14 according to the present invention. Bicycle 10 includes a seat 16 and handlebars 18 that are attached to frame 12. A seat post 20 is connected to seat 16 and slidably engages a seat tube 22 of frame 12. A top tube 24 and a down tube 26 extend forwardly from seat tube 22 to a head tube 28 of frame 12. Handlebars 18 are connected to a stem or steer tube 30 that passes through head tube 28 and is integrally formed with a fork crown 32. Understandably, handlebar 18 may include a stem that is constructed to slidably engage an interior cavity of steer tube 30.

Fork assembly 14 includes a pair of fork blades or fork legs 34 that extend from generally opposite ends of fork crown 32 and are constructed to support a front wheel assembly 36 at an end thereof or dropout 38. Dropouts 38 engage generally opposite sides of an axle 40 constructed to engage a hub 42 of front wheel assembly 36. A number of spokes 44 extend from hub 42 to a rim 46 of front wheel assembly 36. A tire 48 is engaged with rim 46 such that rotation of hub 42 and rim 46, relative to fork legs 34, rotates tire 48.

Bicycle 10 includes a front brake assembly 50 having an actuator 52 attached to handlebars 18 and a pair of brake pads 53 positioned on generally opposite sides of front wheel assembly 36. Brake pads 53 are constructed to engage a brake wall 54 of rim 46 thereby providing a stopping or slowing force to front wheel assembly 36. A rear wheel assembly 56 includes a disc brake assembly 58 having a rotor 60 and a caliper 62 that are positioned proximate a rear axle 64. A rear wheel 66 is positioned generally concentrically about rear axle 64. Understandably, front wheel assembly 36 and rear wheel assembly 56 could be equipped with a brake assembly generally similar to front brake assembly 50 or disc brake assembly 58.

A seat stay 68 and a chain stay 70 offset rear axle 64 from a crankset 72. Crankset 72 includes a set of pedals 74 that is operationally connected to a chain 76 via a chain ring or sprocket 78. Rotation of chain 76 communicates a drive force to a gear cluster 80 positioned proximate rear axle 64. Gear cluster 80 is generally concentrically orientated with respect to rear axle 64 and includes a number of variable diameter gears.

Gear cluster 80 is operationally connected to a hub 82 of rear wheel 66. A number of spokes 84 extend radially between hub 82 and a rim 86 of rear wheel 66 of rear wheel assembly 56. As is commonly understood, rider operation of pedals 74 drives chain 76 thereby driving rear wheel 66 which in turn propels bicycle 10. Fork assembly 14 is constructed to support a forward end 88 of bicycle 10 above a ground surface 90. Handlebar 18 is connected to frame 12 and fork assembly 14 such that operator manipulation of handlebar 18 is communicated to fork assembly 14 to facilitate rotation of front wheel assembly 36 relative to frame 12 along a longitudinal axis of bicycle 10. As is commonly understood, such manipulation of handlebar 18 steers bicycle 10 during riding.

Understandably, the construction of bicycle 10 shown in FIG. 1 is merely exemplary of a number of bicycle configurations. That is, whereas bicycle 10 is shown as what is commonly understood as a street bike, it is appreciated that fork assembly 14 is applicable to other bicycle configurations such as mountain or dirt bikes. It is further appreciated that fork assembly 14 and the method of providing fork assembly 14 is applicable to any of a number of vehicle configurations in addition to the bicycle configuration shown.

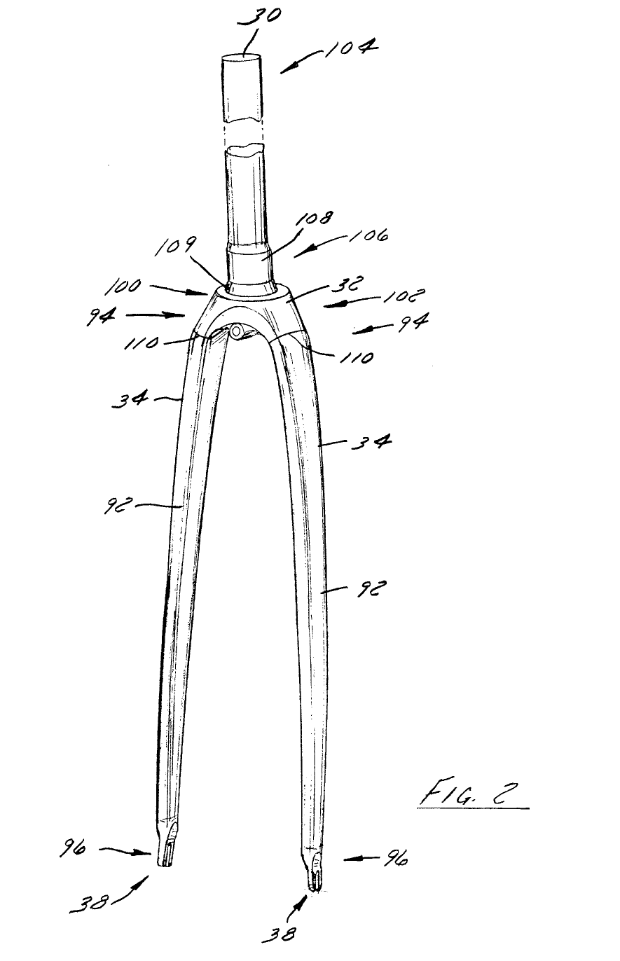

FIGS. 2-4 show fork assembly 14 removed from bicycle 10. Each fork leg 34 includes a body 92 that extends between a first end or fork crown end 94 proximate fork crown 32 and a second end or wheel end 96 having dropout 38 formed thereat. Dropouts 38 are constructed to operatively engage generally opposite sides of axle 40 of front wheel assembly 36. Fork crown 32 includes a main body or a first am 100 and a second arm 102 that are each constructed to receive a fork crown end 94 of a respective fork leg 34.

Steer tube 30 is integrally formed with fork crown 32 and is constructed to extend from fork crown 32 in a direction generally opposite fork legs 34. Steer tube 30 includes a first end 104 constructed to operationally engage handlebar 18 and a second end 106 positioned proximate fork crown 32. A contour 108 is formed proximate second end 106 of steer tube 30 and a bearing race 109 is disposed between contour 108 and fork crown 32. Race 109 is constructed to engage a bearing disposed between fork assembly 14 and head tube 28 of bicycle frame 12. Race 109 may be constructed to support a bearing positioned thereabout or otherwise directly engage head tube 28 of frame 12. Preferably, race 109 is formed integrally with steer tube 30 and fork crown 32. Such a construction provides a robust interface between fork assembly 14 and bicycle 10. Additionally, such a construction allows a bearing to directly engage fork assembly 14 rather than requiring a separate race be disposed therebetween. Preferably, steer tube 30, fork crown 32, and race 108 are concurrently forged. Understandably, other manufacturing protocols, such as casting, molding, are also envisioned. Additionally, race 109 may also be processed, such as by shot or peen hardening, to enhance the wear resistance of the race.

Fork leg bodies 92 are constructed of non-metallic material whereas steer tube 30 and fork crown 32 are constructed of a metal based material. Preferably, bodies 92 are constructed of a carbon fiber material and steer tube 30 and fork crown 32 are constructed as a unitary one-piece aluminum or magnesium based forging. Understandably, steer tube 30, fork crown 32, and bodies 92 could each be constructed of one or more of a metal material, such as aluminum or magnesium, or other materials, such as carbon materials or composites, glass materials or composites, etc. Preferably, fork legs 34 are formed of a composite material that includes one or more of carbon glass fiber, carbon fiber, glass fiber, resin, and epoxy. An interface 110 is formed at the connection between each fork leg 34 and fork crown 32 and provides a visible indication of the composite nature of fork assembly 14.

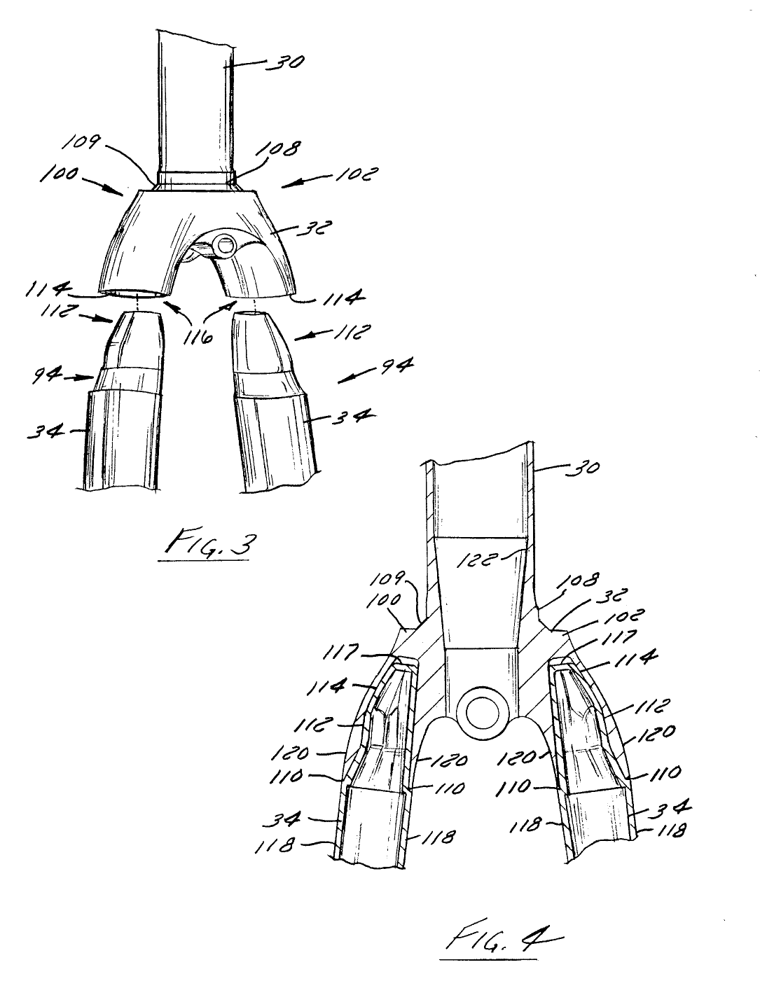

As shown in FIGS. 3 and 4, fork crown end 94 of each fork leg 34 includes a contour 112 constructed to generally match a contour 114 of a cavity 116 formed in each arm 100, 102 of fork crown 32. Contours 112, 114 are constructed to generally cooperate to define the orientation of each fork leg 34 relative to respective arms 100, 102 of fork crown 32. As shown in FIG. 4, contours 112, 114 are constructed to substantially match one another such that fork legs 34 are received in cavities 116 and can thereby be bonded to fork crown 32.

Cavities 116 extend a majority of a depth of arms 100, 102 and thereby increase the bonding surface area between legs 34 and fork crown 32. Cavities 116 are also contoured to prevent axial rotation of fork legs 34 when fork crown ends 94 of fork legs 34 are positioned therein. Understandably, the surface area of the crown end 94 of each fork leg 34 gradually reduces from a position proximate interface 110 to a distal tip 117 of the fork crown end 94 of each fork leg 34. Furthermore, as the bonded interfaces of fork legs 34 and fork crown 32 are internal to the finished assembly, the bonded portions of fork legs 34 and fork crown 32 do not require any pre-bond machining to ensure a generally uniform bond interface. That is, as the bond is formed between mating faces of molded parts, any bond gap can be more readily monitored and manipulated during the manufacturing process to provide a generally consistent bond gap.

Still referring to FIG. 4, contours 112, 114 are also constructed such that an outer surface 118 of fork legs 34 is generally aligned with an outer surface 120 of fork crown 32 when fork legs 34 are secured or otherwise bonded thereto. That is, an outer contour of the cast fork crown proximate the blind or not through opening of each of cavities 116 substantially matches an outer contour of a portion of the fork leg 34 positioned generally adjacent the opening. Such a construction reduces, if not completely eliminates, machining of fork assembly 14 after the fork legs 34 have been bonded or otherwise secured to fork crown 32. Such a construction also forms a generally continuous and relatively planar exterior surface of fork assembly 14. The reduced post bonding manipulation of fork assembly 14 reduces manufacturing expenses associated with fork assembly production as well as provides a fork assembly that is highly aerodynamic.

In addition to increasing the bond surface area between fork legs 34 and fork crown 32, cavities 116 reduce the mass of fork crown 32 by approximately 100 to 150 grams as compared to a fork crown not having such cavities or having a protrusion constructed to otherwise engage a cavity formed in a corresponding fork leg. Accordingly, fork assembly 14 provides a unitary fork and steer tube assembly that reduces the overall mass of the bicycle equipped therewith.

As shown in FIG. 4, a cross-sectional shape of forged fork crown 32 includes the formation of the pair of female sockets, pockets, or cavities 116 constructed to receive a correspondingly shaped portion of each fork leg 34. An interior surface 122 of the steer tube 30 of fork assembly 14 is tapered and constructed to operative engage handlebar 18 or a handlebar stem. As shown in FIG. 4, steer tube 30 and fork crown 32 are formed during forging of the fork assembly 14. There is no bond joint between steer tube 30 and fork crown 32 thereby reducing the potential for failure thereat. Furthermore, such a construction eliminates the common alternative of over-sizing of the materials proximate the interface between the steer tube and fork stem. Such a construction allows for even greater reduction in the material required to form fork assembly 14.

Steer tube 30 also includes race 108 formed proximate fork crown 32. As race 108 is formed on fork assembly 14 during forging, any machining of race 108 occurs prior to the investment of time and resources associated with bonding fork legs 34 to fork crown 32. Such a construction minimizes the impact of manufacturing defects by providing for the removal of defective forged parts earlier during the manufacturing process. That is, any production errors associated with the forging or machining of fork crown 32 and steer tube 30 can be resolved and corrected prior to the investment associated with the bonding of fork legs 34. Accordingly, fork assembly 14 is robust, lightweight, and economical and efficient to manufacture.

Therefore, one embodiment includes a bicycle fork assembly having a fork crown and a steer tube formed integrally with the fork crown. The steer tube extends from the fork crown in a first direction. A pair of cavities is formed in the fork crown. Each cavity has an opening that faces a direction generally opposite the first direction. The fork assembly includes a pair of fork legs. Each fork leg is formed of a non-metal material and has a first end that is contoured to substantially match a contour of one of the cavities such that the pair of fork legs can be bonded into the cavities.

Another embodiment includes a bicycle assembly that has a frame assembly constructed to support a rear wheel and a seat. The bicycle assembly includes a front wheel support assembly that has a steer tube constructed to be rotationally connected to the frame assembly. A fork crown is integrally formed with the steer tube and is constructed to extend below a forward portion of the frame assembly. A pair of recesses is formed into generally opposite ends of the fork crown such that each recess has a single opening orientated such that the openings face in a common direction. A pair of composite fork legs is bonded to the fork crown. Each fork leg has a projection that is constructed to cooperate with one of the recesses such that the projection is entirely enclosed by the fork crown when the fork leg is bonded to the fork crown.

Another embodiment includes a method of forming a fork assembly. The method includes forming a fork crown and a steer tube as a one-piece part. A cavity is formed through the steer tube and a pair of pockets is formed in the fork crown. A fork leg is formed of a composite material that is different than a material of the one-piece part. An upper portion of the fork leg is contoured during formation to correspond to a contour of one of the pockets. The upper portion of the fork leg is bonded into one of the pockets of the fork crown such that an outer surface of the fork leg is generally aligned with an outer surface of the fork crown.

A further embodiment includes a method of forming a fork assembly wherein a steer tube for engaging a head tube and a fork crown are concurrently formed. A bearing race is integrally formed on one of the steer tube and the fork crown.

The present invention has been described in terms of the preferred embodiment, and it is recognized that equivalents, alternatives, and modifications, aside from those expressly stated, are possible and within the scope of the appending claims.

What is claimed is:

1. A bicycle fork assembly comprising:
a fork crown;
a steer tube formed integrally with the fork crown and extending in a first direction;
a pair of cavities formed in the fork crown, each cavity having an opening facing a direction generally opposite the first direction; and
a pair of fork legs, each fork leg formed of a non-metal material and having a first end with a contour that substantially matches a contour of one of the cavities such that the pair of fork legs can be bonded into the cavities.

2. The bicycle fork assembly of claim 1 wherein the fork crown and the steer tube are integrally formed by forging.

3. The bicycle fork assembly of claim 1 further comprising a bearing race formed integrally on one of the fork crown and the steer tube and configured to engage a bearing.

4. The bicycle fork assembly of claim 1 wherein the steer tube tapers from a first end proximate the crown to a second end constructed to engage a handlebar.

5. The bicycle fork assembly of claim 1 wherein the cast fork crown is approximately 100 grams to approximately 150 grams lighter than a fork crown without cavities.

6. The bicycle fork assembly of claim 1 wherein the cavities extend a majority of a depth of a main body of the fork crown.

7. The bicycle fork assembly of claim 1 wherein an outer contour of the fork crown proximate the openings substantially matches an outer contour of an exposed portion of a respective fork leg positioned generally adjacent the opening when the fork leg is secured to the crown.

8. The bicycle fork assembly of claim 7 wherein a surface area of the first end of each fork leg gradually reduces from a position proximate the exposed portion to a tip of the first end.

9. The bicycle fork assembly of claim 1 wherein each fork leg is formed of composite material that includes at least two of carbon, glass fiber, carbon fiber, resin, and epoxy.

10. A bicycle assembly comprising:
a frame assembly constructed to support a rear wheel and a seat; and
a front wheel support assembly comprising:
a steer tube constructed to be rotationally connected to the frame assembly;
a fork crown integrally formed with the steer tube and constructed to extend below a forward portion of the frame assembly;
a pair of recesses formed into generally opposite ends of the fork crown, each recess having a single opening orientated such that the openings face in a common direction; and
a pair of composite fork legs bonded to the fork crown, each fork leg having a projection constructed to cooperate with one of the recesses such that the projection is entirely enclosed by the fork crown when the fork leg is bonded to the fork crown.

11. The bicycle assembly of claim 10 wherein the steer tube and the fork crown and integrally formed during a common forging.

12. The bicycle assembly of claim 11 wherein the pair or recesses are forged during or after the common forging.

13. The bicycle assembly of claim 10 further comprising a bearing race that is forged on the front wheel assembly.

14. The bicycle assembly of claim 10 further comprising a handlebar stem constructed to slidably engage an interior cavity of the steer tube.

15. The bicycle assembly of claim 10 wherein a contour of each projection is constructed to cooperate with a contour of a respective recess and prevent axial rotation between therebetween.

16. The bicycle assembly of claim 10 wherein a contour of each projection and respective recess defines an orientation of the pair of composite forks with respect to the fork crown.

17. The bicycle assembly of claim 10 wherein the fork crown and the pair of composite forks are formed from one or more of a metal material, an aluminum-type material, a magnesium-type material, a carbon material, a carbon fiber material, a glass material, a glass fiber material, an epoxy, and a resin.

18. The bicycle assembly of claim 17 wherein the fork crown is formed from one or more of the metal material, the aluminum-type material, and the magnesium-type material and the pair of composite forks are formed from one of more of the carbon material, the carbon fiber material, the glass material, the glass fiber material, the epoxy, and the resin.

19. The bicycle assembly of claim 10 wherein all but a crown portion of an interior cavity of the steer tube is forged in a final shape.

20. The bicycle assembly of claim 19 wherein the interior cavity of the steer tube is forged with a taper.

21. The bicycle assembly of claim 20 wherein the recesses are formed in final shape.

22. A method of forming a fork assembly comprising:
forming a fork crown and a steer tube as a one-piece part;
forming a cavity through the steer tube and a pair of pockets in the fork crown;
forming a fork leg of a composite material that is different than a material of the one-piece part;
contouring an upper portion of the fork leg during forming of the fork leg to correspond to a contour of one of the pockets; and
bonding the upper portion of the fork leg into the one of the pockets of the fork crown such that an outer surface of the fork leg is generally aligned with an outer surface of the fork crown.

23. The method of claim 22 further comprising forming the pockets and forming the fork leg such that the contour of the upper portion of the fork leg and the contour of the pockets cooperate to define an orientation of the fork leg relative to the fork crown.

24. The method of claim 22 further comprising providing a bladder for forming at least one of the cavity and the pair of pockets.

25. The method of claim 22 wherein the one-piece part is formed of a metal material and the fork leg is formed of a carbon fiber material.

26. The method of claim 22 further comprising tapering the cavity of the steer tube during forming.

27. The method of claim 22 further comprising forging the one-piece part.

28. The method of claim 22 further comprising forming a bearing race on the one-piece part.

29. A method of forming a fork assembly comprising:
concurrently forming a steer tube for engaging a head tube and a fork crown; and
integrally forming a bearing race on one of the steer tube and the fork crown.

30. The method of claim 29 wherein the forming of the steer tube and the fork crown is by one of forging, casting, and molding.
